(19) United States
(12) Patent Application Publication
(10) Pub. No.: US 2017/0302912 A1
(43) Pub. Date: Oct. 19, 2017

(54) METHOD AND DEVICE FOR ENHANCING RESOLUTION OF VIEWPOINT IMAGE OF GLASSLESS THREE-DIMENSIONAL (3D) DISPLAY

(71) Applicant: ELECTRONICS AND TELECOMMUNICATIONS RESEARCH INSTITUTE, Yuseong-gu (KR)

(72) Inventors: Ho Min EUM, Yuseong-gu (KR); Gwang Soon LEE, Yuseong-gu (KR)

(73) Assignee: ELECTRONICS AND TELECOMMUNICATIONS RESEARCH INSTITUTE, Yuseong-gu (KR)

(21) Appl. No.: 15/487,904

(22) Filed: Apr. 14, 2017

(30) Foreign Application Priority Data
Apr. 15, 2016 (KR) 10-2016-0046464

(51) Int. Cl. H04N 13/04; H04N 13/00

(52) U.S. Cl. CPC H04N 13/0413; H04N 13/0007

(57) ABSTRACT

A method and device for increasing a resolution for each viewpoint in a glassless three-dimensional (3D) display. A method of controlling a three-dimensional (3D) display device including a display panel and a lens includes performing time-division on a plurality of viewpoint images such that each of the viewpoint images is divided into n division images, transferring the division images to the display panel by increasing n times a frame rate of the division images, and controlling the lens such that the division images transferred to the display panel pass through a lens cell.

### CROSS-REFERENCE TO RELATED APPLICATION(S)

This application claims the priority benefit of Korean Patent Application No. 10-2016-0046464 filed on Apr. 15, 2016, in the Korean Intellectual Property Office, the disclosure of which is incorporated herein by reference for all purposes.

### BACKGROUND

### 1. Field

One or more example embodiments relate to a method and device for enhancing a resolution for each viewpoint displayed in a glassless three-dimensional (3D) display.

### 2. Description of Related Art

Using existing technology, a user may view a three-dimensional (3D) image with special glasses. However, a glassless 3D display device that allows a user to view a 3D image without special glasses has been introduced recently.

A parallax barrier, a lenticular lens, or a microlens array may be attached in front of a display panel included in a glassless 3D display device.

A method of using a parallax barrier may dispose a number of barriers in front of a display panel at predetermined intervals to allow light to selectively pass through an opening of the parallax barrier based on a direction of each of barriers, such that a plurality of viewpoint images included in light are aggregated at different positions from a viewing distance. A method of using a parallax barrier may create a 3D effect by causing a parallax to occur only with respect to one direction based on a direction of each of barriers disposed in front of a display, but there is a disadvantage to using such method, which is that a viewpoint image is relatively dark due to a relatively low light efficiency.

A method of using a lenticular lens may dispose a plurality of semicylindric lenses in front of a display panel such that a plurality of viewpoint images that pass through the semicylindric lenses are accumulated at different positions from a viewing distance. The method of using the lenticular lens may provide a higher light efficiency and an enhanced viewing angle than the method of using the parallax barrier, but the method of using the lenticular lens may create a 3D effect only with respect to one direction like the method of using the parallax barrier.

A method of using a microlens array may be used as an extension of the method of using the lenticular lens using the semicylindric lenses and may use a microlens having a circular shape, a hexagonal shape, and a rectangular shape to create a 3D effect by causing a parallax to occur with respect to an orthogonal direction. In any case, as the number of viewpoint images increases, the resolution per reconstructed viewpoint image decreased due to the limited resolution of the display panel

### SUMMARY

An aspect provides a method and device for mapping a viewpoint image on a display panel by performing time-division and moving a lens to solve an issue of a resolution of each viewpoint decreasing when a glassless three-dimensional (3D) image is displayed.

According to an aspect, there is provided a three-dimensional (3D) display device including a display panel configured to output a plurality of viewpoint images each including a frame of an input image through a plurality of pixels, a lens configured to allow the viewpoint images output by the display panel to pass through the lens, and a processor configured to control the display panel and the lens, wherein the processor is configured to perform time-division on the viewpoint images such that each of the viewpoint images is divided into n division images, transfer the division images to the display panel by increasing n times a frame rate of the division images, and control the lens such that the division images transferred to the display panel pass through a lens cell.

The processor may be configured to control the lens such that a first division image among the division images passes through a lens cell disposed at a first point, and control the lens such that a second division image among the division images passes through the lens cell moved from the first position to a second position, and an n-th division image may pass through a lens cell moved to an n-th position.

The processor may be configured to transfer a first division image among the division images to the display panel based on a first mapping method, and transfer a second division image among the division images to the display panel based on a second mapping method.

The processor may be configured to increase N times a resolution of each of the viewpoint images and perform time-division on the viewpoint images of the n times increased resolution such that each of the viewpoint images of the n times increased resolution is divided into n division images.

According to another aspect, there is provided a method of controlling a three-dimensional (3D) display device including a display panel and a lens, the method including performing time-division on a plurality of viewpoint images such that each of the viewpoint images is divided into n division images, transferring the division images to the display panel by increasing n times a frame rate of the division images, and controlling the lens such that the division images transferred to the display panel pass through a lens cell.

The method may further include controlling the lens such that a first division image among the division images passes through a lens cell disposed at a first point, and controlling the lens such that a second division image among the division images passes through the lens cell moved from the first position to the second position.

The method may further include transferring a first division image among the division images to the display panel based on a first mapping method, and transferring a second division image among the division images to the display panel based on a second mapping method.

The method may further include increasing n times a resolution of each of the viewpoint images and performing time-division on the viewpoint images of the n times increased resolution such that each of the viewpoint images of the n times increased resolution is divided into n division images.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a display device according to an example embodiment;

FIG. 2 is a flowchart illustrating a process of outputting a three-dimensional (3D) image in a display device according to an example embodiment;

FIGS. 3A and 3B each illustrate a method of mapping a viewpoint image on a display panel in a display device according to an example embodiment;

FIGS. 4A and 4B each illustrate a process of generating a plurality of viewpoint images in a display device according to an example embodiment;

FIGS. 5A through 5D each illustrate a process of outputting a plurality of viewpoint images in a display device according to an example embodiment; and

FIG. 6 is a flowchart illustrating a process of outputting a plurality of images in a display device according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

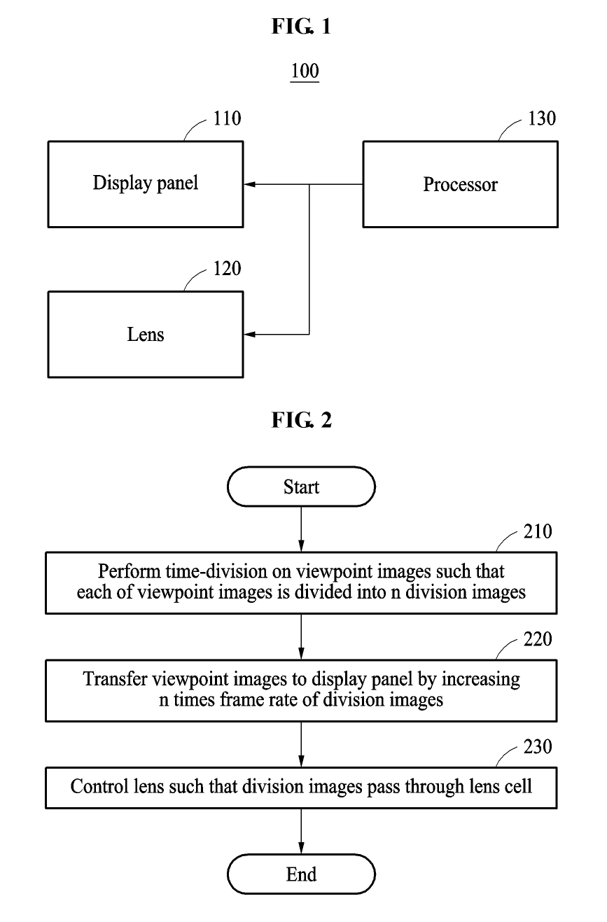

FIG. 1 is a block diagram illustrating a display device according to an example embodiment.

A display device 100 includes a display panel 110 configured to output a plurality of viewpoint images each including a frame of an input image through a plurality of pixels, a lens 120 configured to allow the viewpoint images output by the display panel to pass through the lens, and a processor 130 configured to control the display panel 110 and the lens 120.

The display panel 110 may receive a viewpoint image from a light source disposed to face one side portion of the display panel 110 and output the received viewpoint image through the plurality of pixels included in the display panel 110. For example, the display panel 110 that performs such a role may be flexible, visible, or wearable. The display panel 110 may include a touch panel and at least one module.

The lens 120 may be provided in front of the display panel 110 and may refract the viewpoint image output by the display panel 110.

The processor 130 may control the display panel 110 or the lens 120 included in the display device 100. The processor 130 may be electrically connected to a memory (not shown) to be included in the display device 100 and execute instructions stored in the memory. For example, the processor 130 may execute the instructions for generating a viewpoint image or instructions for changing a position of the lens 120, or store instructions received from a user.

The display device 100 may include a portion or all of the above-described constituent elements, and an extra constituent element may be added to the display device 100 within a scope that is easily changeable by those skilled in the art.

FIG. 2 is a flowchart illustrating a process of outputting a three-dimensional (3D) image in a display device according to an example embodiment.

A display device may include a processor, for example, the processor 130 of FIG. 1. The processor may edit or delete viewpoint images input to the display device such that a three-dimensional (3D) image is provided which a user may view without wearing special glasses.

In operation 210, the processor performs time-division on the viewpoint images in order to increase n times an output resolution of the viewpoint images such that each of the viewpoint images is divided into n division images. The processor may also increase n times a frame rate of the division images. For example, the processor may perform time-division on an existing viewpoint image in order to increase twice the output resolution of the existing viewpoint image such that the existing viewpoint image is divided into two division images, and may increase twice the frame rate of two division images.

In an example, time-division may be performed on an existing viewpoint image such that the existing viewpoint image is divided into two division images. In this example, the time-division may be performed such that an existing viewpoint image is divided into an odd numbered pixel image, for example, a first division image, and an even numbered pixel image, for example, a second division image.

In an example, when B viewpoint images of a high definition (HD)-level resolution for each viewpoint are output, a rate of concurrently mapping each of the viewpoint images to a plurality of pixels included in the display panel may be a b/B level in response to the resolution of the display panel being an HD*b level (b times of HD level). For example, when a plurality of viewpoint images includes ten viewpoint images of the HD-level resolution for each viewpoint and the display panel has HD*5-level resolution, the rate of concurrently mapping each of ten viewpoint images to the pixels included in the display panel may be an 1/2(=15/10) level. Since a total resolution of the viewpoint images is an HD*10-level (ten HD-level viewpoint images) and the resolution of the display panel to output the viewpoint images is an HD*5 level, only a half resolution of the viewpoint images may be output.

In this example, when the time-division is performed on each of the viewpoint images to divide each of the viewpoint images into two division images and the frame rate is increased twice and the increased frame rate is output, the output resolution may be maintained. For example, the time-division may be performed on each of ten HD-level viewpoint images included in the viewpoint images such that each of the ten HD-level viewpoint images is divided into an odd numbered pixel image, for example, a first division image, and an even numbered pixel image, for example, a second division image. Each of ten odd numbered pixel images and each of ten even numbered pixel images may have an HD/2-level of resolution because the odd numbered pixel images and the even numbered pixel images are results of dividing each of the ten HD-level viewpoint images into two images. A total resolution of ten odd numbered pixel images on which the time-division is performed may be an HD/2*10 level. Likewise, a total resolution of ten even numbered pixel images on which the time-division is performed may be an HD/2*10 level. Each of the odd numbered pixel images or each of the even numbered pixel images may be mapped to each of the pixels included in the display panel of the HD*5-level resolution. The processor may increase twice the frame rate of the viewpoint images divided into the odd numbered pixel images and the even numbered pixel images compared to existing viewpoint images, and control the odd numbered pixel images and the even numbered images such that the odd numbered pixel images and the even numbered images are alternately output.

In operation 220, the processor transfers the generated odd numbered pixel images and the even numbered pixel images to the display panel at predetermined intervals.

In an example, the processor may transfer a first division image among the division images to the display panel based on a first mapping method, and transfer a second division image among the division images to the display panel based on a second mapping method. For this example, it is described that the processor transfers the first division image and the second division image to the display panel based on two different mapping methods, but the present disclosure is not limited thereto. The processor may transfer each of the first division images through an n-th division image to the display device based on the first mapping method through an n-th mapping method.

In an example, the processor may map the odd numbered pixel images and the even numbered pixel images to the pixels included in the display panel based on different methods. For example, the odd numbered pixel images may be mapped to the pixels included in the display panel based on a method identical to the method of mapping the existing viewpoint images. Simultaneously, the even numbered pixel images may be mapped to the pixels included in the display panel based on a mapping method obtained by partially changing a mapping method used for mapping the odd numbered pixel images.

In an example, the processor may determine an order such that the odd numbered pixel images and the even numbered pixel images are alternately transferred to the display panel at predetermined intervals. For example, an odd numbered pixel image of a K-th viewpoint image may be transferred to the display panel during a first unit time, and an even numbered pixel image of the K-th viewpoint image may be transferred to the display panel during a second unit time. An odd numbered pixel image of a K+1-th viewpoint image may be transferred to the display panel during a third unit time, and an even numbered pixel image of the K+1-th viewpoint image may be transferred to the display panel during a fourth unit time.

In operation 230, the processor moves a position of a lens in response to a type of a pixel image transferred to the display panel. For example, when it is verified that an odd numbered pixel image passes through the display panel, the processor may control the lens such that the lens is located at a position identical to a position at which an existing viewpoint image is output. When it is verified that an even numbered pixel image passes(*will pass? shall pass? is passing? through the display panel, the processor may control the lens such that the lens is moved from the position at which the existing viewpoint image is output to a preset position.

In an example, the processor may control the lens such that the first division image among the division images passes through a lens cell disposed at a first position, and control the lens such that the second division image among the division images passes through the lens cell disposed at a second position. Although the present disclosure describes that the processor controls the lens such that the first division image and the second division image pass through the lens cell moved to be disposed at different positions, the present disclosure is not limited thereto. Each of the first division image through an n-th division image may pass through the lens cell moved to the first position through an n-th position. Description of operations 210 through 230 is only description of an example of when an existing viewpoint image is divided into two division images, and the present disclosure are not limited to the example. According to example embodiments of the present disclosure, n may be a natural number greater than or equal to 2. For example, the processor may perform time-division on an existing viewpoint image such that the viewpoint image is divided into five division images, and increase five times a frame rate of the five division images.

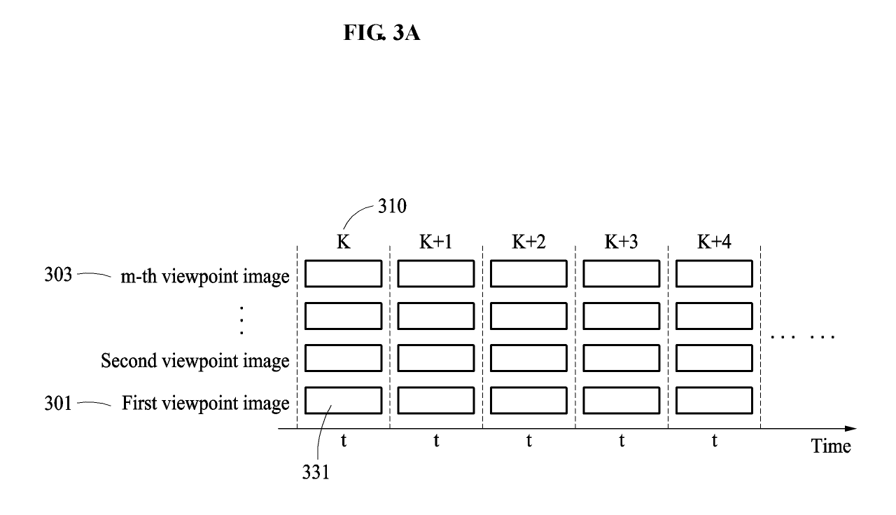

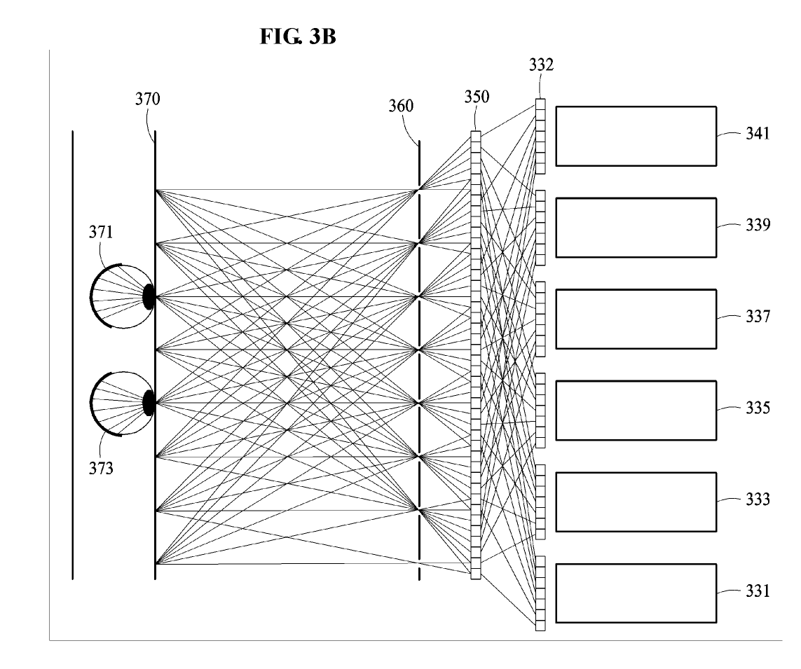

FIG. 3A illustrates a method of mapping a viewpoint image on a display panel in a display device according to an example embodiment.

FIG. 3A includes a plurality of frames divided at predetermined intervals. For example, in the FIG. 3A, a first viewpoint image 301 may include a K-th frame through a K+a-th frame divided based on a time t. Similarly, a K-th frame group may include the K-th frame of the first viewpoint image 301 through a K-th frame of an m-th viewpoint image 303.

The K-th frame group through a K+a-th frame group may include frames of each of the first viewpoint image 301 through the m-th viewpoint image 303. Each frame group may be output at predetermined intervals. The time t corresponding to a time interval for outputting a single frame group may be changeable by a user setting.

FIG. 3B illustrates a method of mapping a viewpoint image on a display panel in a display device according to an example embodiment.

Frames 331, 333, 335, 337, 339, and 341 of a plurality of viewpoint images, for example, a first viewpoint image through an m-th viewpoint image, included in the K-th frame group 310 may be provided for eyes 371 and 373 of a user through a display panel 350 and a lens 360 during the time t.

The method of mapping each viewpoint image to pixels included in the display panel 350 is described as follows. For example, it is assumed that a number of horizontal pixels included in the display panel 350 is N and a number m of viewpoint images is 6 (N is assumed to be a multiple of 6 for ease of description). Referring to FIG. 3B, six frames 331, 333, 335, 337, 339, and 341 are included in the first viewpoint image through a sixth viewpoint image, respectively. A number of the horizontal pixels 332 for each viewpoint image required for mapping the first viewpoint image through the sixth viewpoint image on the display panel 350 including the N horizontal pixels 332 may be N/6. In detail, referring to FIG. 3B, the number N of the horizontal pixels 350 included in the display panel 350 is 42, a number m of the viewpoint images is 6, and a number N/6 of the horizontal pixels 332 for each viewpoint image is 7. The horizontal pixels 332 for each viewpoint image illustrated in FIG. 3B may be understood as indicating that each of the frames 331, 333, 335, 337, 339, and 341 of the viewpoint images are constituted by a single unit.

In an example, the horizontal pixels 332 included in the K-th frame 331 of the first viewpoint image 301 may be mapped to the horizontal pixels 350 of the display panel 350 at the predetermined intervals. For example, the value of the j-th pixel belonging to the K-th frame of the m-th viewpoint image may be defined as I_{K,m,j}. The value of the m+6j-th pixel of the display panel in the K-th frame may be defined as P_{K,m+6j} and mapped as P_{K,m+6j}=I_{K,m,j}.

(1≦m≦6,0≦∥≦N/6−1,m,j:integer)

In an example, the viewpoint images that pass through the horizontal pixels 350 included in the display panel 350 may pass through the lens 360. The lens 360 may only allow a viewpoint image incident at a predetermined angle or in a predetermined direction among the viewpoint images passing through the lens 360 to be output. The viewpoint images that pass through the lens 360 may be transferred to the eyes 371 and 373 of the user located at a viewing distance 370.

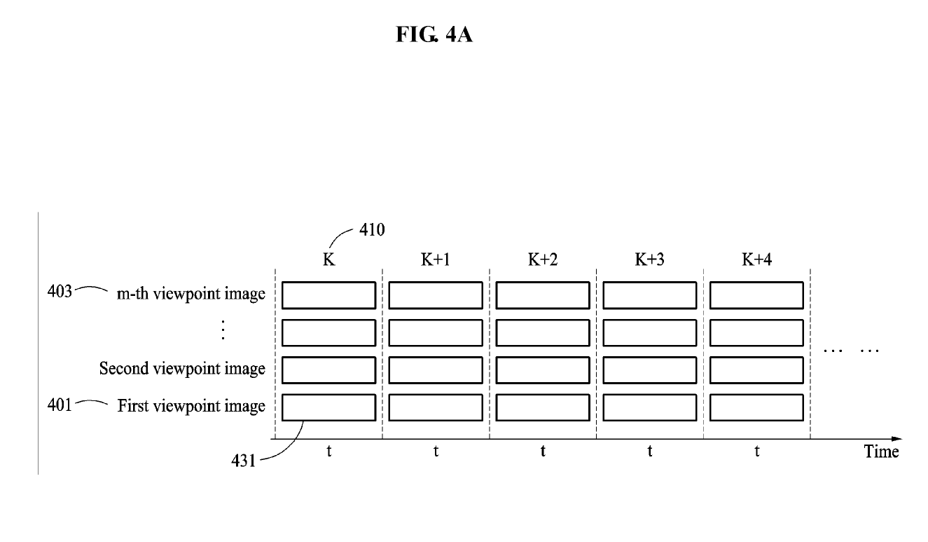

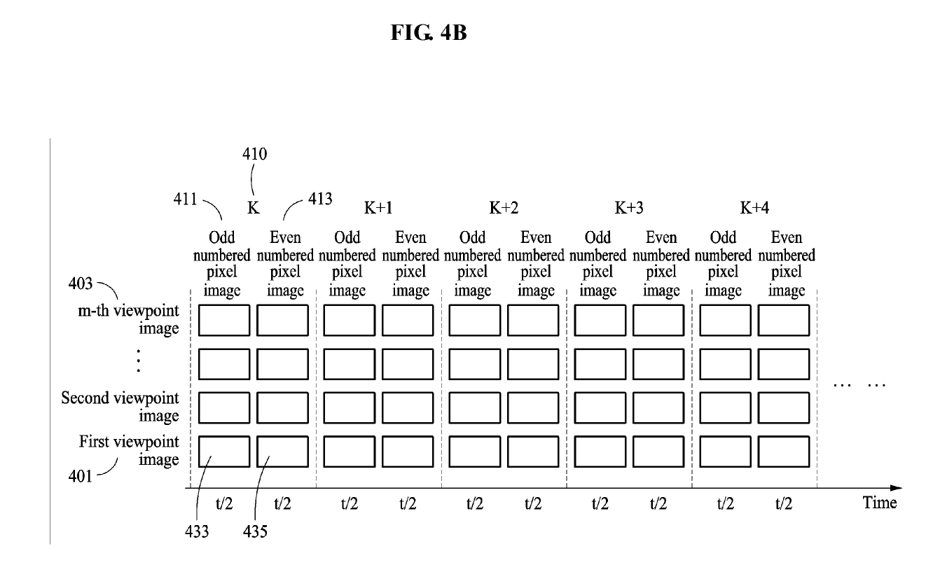

FIG. 4A illustrates a process of generating a plurality of viewpoint images in a display device according to an example embodiment

In FIG. 4A, a plurality of frames is included in a K-th frame group 410 through a K+4-th frame group. In an example, a frame 431 included in a first viewpoint image 401 and the K-th frame group 410 may be transferred to a user through a display panel and a lens during a unit time t. The frame 431 may be divided into at least two pixel images. Also, a division image may include a plurality of pixel images.

FIG. 4B illustrates a method of dividing each of viewpoint images into at least two pixel images in a display device.

A processor may divide each frame included in the viewpoint images into an odd numbered pixel image group 411 and an even numbered pixel image group 413. For example, the frame 431 of the first viewpoint image 401 included in the K-th frame group 410 may be divided into odd numbered pixel images including an odd numbered pixel image 433, for example, a first division image, and even numbered pixel images including an even numbered pixel image 435, for example, a second division image, during the unit time t.

In an example, the unit time t allocated to an undivided frame may be equally divided and allocated to each of the pixel images divided into the odd numbered pixel images and the even numbered pixel images. The unit time t may be equally divided and allocated to an odd numbered pixel image and an even numbered pixel image based on a method of increasing each frame rate compared to an existing frame rate. For example, when a frame rate of each of the odd numbered pixel image 433 and the even numbered pixel image 435 is increased twice, the odd numbered pixel image 433 may be transferred to the user during a time t/2. The even numbered pixel image 435 may be also transferred to the user during the time t/2. The odd numbered pixel image 433 and the even numbered pixel image 435 to which the unit time t is allocated may be alternately output during the unit time t. Based on such method, a frame group to be output after the K-th frame group is output may be also divided into odd numbered pixel images and even numbered pixel images.

In an example, before each of frames included in an existing viewpoint image are divided into odd numbered pixel images and even numbered pixel images, a viewpoint image of which a number of horizontal pixels included in the viewpoint image or a number of vertical pixels included in the viewpoint image is increased by x times may be generated in order to enhance a resolution corresponding to the viewpoint image. For example, in order to increase twice, the number of horizontal pixels of the frame included in the viewpoint image, the number of the horizontal pixels of the frame may be

$$x \times \frac{N}{m} .$$

Here, N denotes a number of horizontal pixels of the display panel, and m denotes a number of viewpoint images. When it is assumed that the number N of the horizontal pixels included in the display panel is 42, and the number n of the viewpoint images is 6,

$$x \times \frac{N}{m}$$

may be 14 in case the number N of the horizontal pixels for each viewpoint image is increased twice.

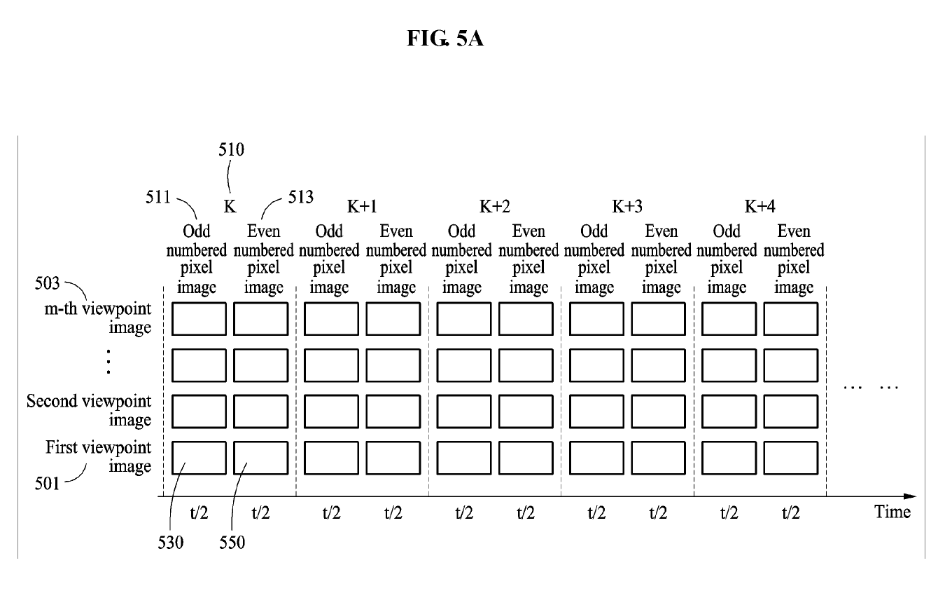

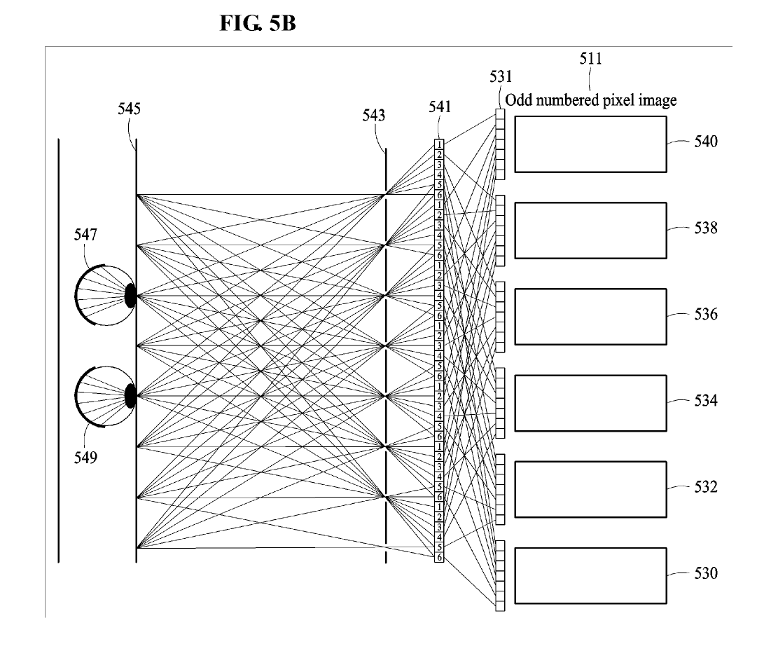

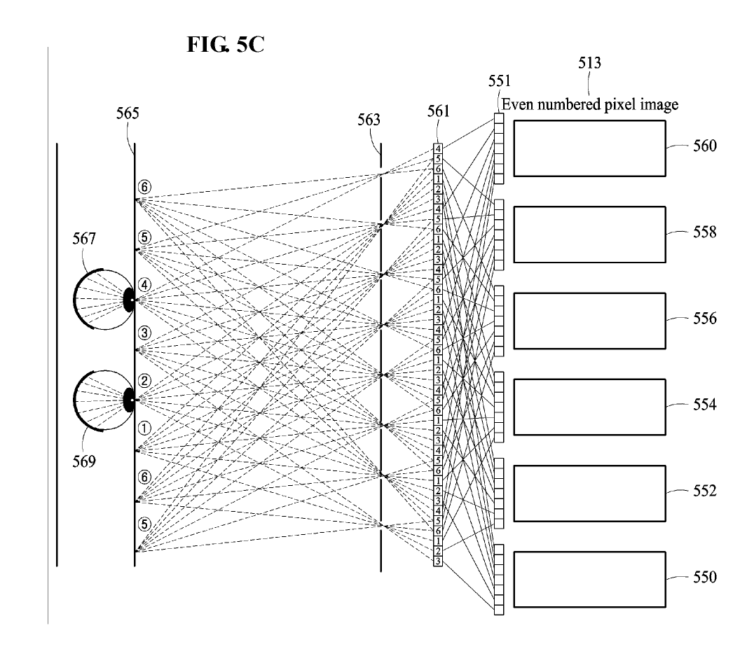

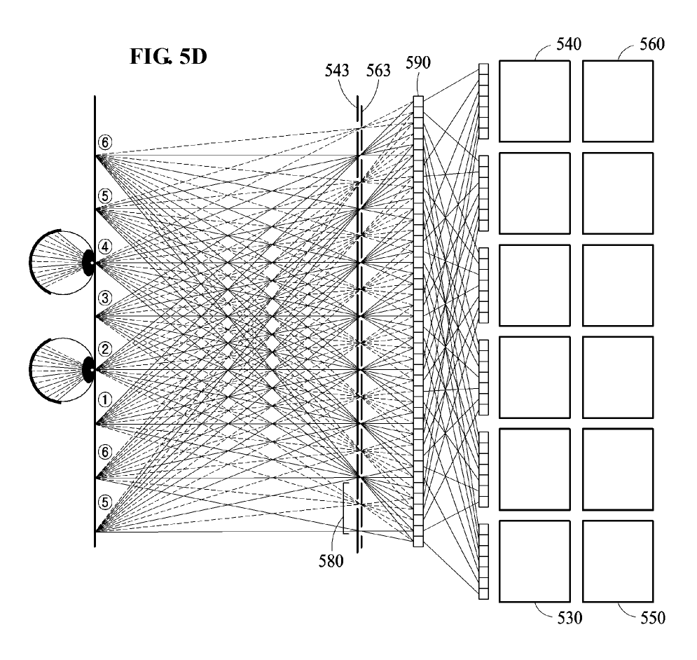

FIGS. 5A through 5C each illustrate a process of outputting a plurality of viewpoint images in a display device according to an example embodiment.

FIG. 5A illustrates a plurality of frame groups including a K-th frame group 510 through a K+a-th frame group divided based on a unit time t among frames included in a first viewpoint image 501 through an m-th viewpoint image 503. Here, a is a natural number. Each of the frames included in the K+a-th frame group may be divided into odd numbered pixel images and even numbered pixel images.

In an example, an odd numbered pixel image group 511 and an even numbered pixel image group 513 included in the K-th frame group 510 may be alternately output.

FIG. 5B illustrates a process of transferring the odd numbered pixel image group 511 included in the K-th frame group 510 to a user. A plurality of odd numbered pixel images 530, 532, 534, 536, 538, and 540 included in the odd numbered pixel image group 511 may be transferred to the user through pixels 541 included in a display panel and a lens 543. Here, a division image may include the odd numbered pixel images 530, 532, 534, 536, 538, and 540.

In an example, a method of mapping the odd numbered pixel image 530 included in the K-th frame group 510 of the first viewpoint image 501 to pixels included in the display panel is described based on horizontal pixels. In this example, the odd numbered pixel image 530 included in the K-th frame group 510 may include horizontal pixels, for example, horizontal pixels 531. The horizontal pixels 531 included in the K-th frame group 510 of the first viewpoint image 501 may be mapped to vertical pixels 541 of the display panel at predetermined intervals. For example, the value of the j-th pixel of an odd numbered pixel image belonging to the K-th frame of the m-th viewpoint image may be defined as I_{o,K,m,j}. The value of the m+6j-th pixel of the display panel in the K-th frame for the odd numbered pixel image may be defined as P_{o,K,m+6j} and mapped as

$${P}_{o , K , m + 6 j} = {I}_{o , K , m , j} \cdot ( 1 \leq m \leq 6.0 \leq j \leq \frac{N}{6} - 1 , m , j \text{:} integer )$$

In an example, odd numbered pixel images may be mapped based on a method used for mapping existing viewpoint images on the display panel.

FIG. 5C illustrates a process of transferring the even numbered pixel image group 513 included in the K-th frame group 510 to the user. A plurality of even numbered pixel images 550, 552, 554, 556, 558, and 560 included in the even numbered pixel image group 513 may be transferred to the user through pixels included in the display panel and a lens 563. Here, a division image may include the even numbered pixel images 550, 552, 554, 556, 558, and 560.

In an example, a method of mapping the even numbered pixel image 550 included in the K-th frame group 510 of the first viewpoint image 501 to pixels included in the display panel is described based on horizontal pixels. In this example, the even numbered pixel image 550 included in the K-th frame group 510 may include the horizontal pixels. Horizontal pixels 551 included in the K-th frame group 510 of the first viewpoint image 501 may be mapped to horizontal pixels 561 of the display panel at predetermined intervals.

In an example, the even numbered pixel image 550 may be mapped to pixels of the display panel based on a method differing from a method used for mapping the pixels of the display panel to the odd numbered pixel image 530. For example, when an even numbered pixel image is mapped to the horizontal pixels 561 of the display panel, the mapping may be performed by moving a mapping position by 3 (=6/2, number of viewpoint images/2). Simultaneously, the lens 563 may be moved by (a half of lens pitch).

$$\frac{{L}_{p}}{2}$$

A method of mapping even numbered pixel images based on a method differing from a method used for mapping odd numbered pixel images may allow light paths (indicated by dotted lines) of the even numbered pixel images to be transferred to each converging (*convergence point, for example, \textcircled{1} through \textcircled{6} of FIG. 5C, identical to those of light paths of the odd numbered pixel images, and the light paths of the even numbered pixel images to be transferred through spaces between the light paths of the odd numbered pixel images. Based on the method, a resolution of each of the viewpoint images may be enhanced because the even numbered pixel images and the odd numbered pixel images may reach an identical converging(*convergence point without the even numbered pixel images and the odd numbered pixel images overlapping or interfering with each other.

In an example, an after-image effect of the previously projected odd numbered pixel images may be added to the even numbered pixel images alternately projected to eyes of the user at a time interval t/2 and thus, the resolution of each of the viewpoint images may be increased twice.

For example, the value of the j-th pixel of an even numbered pixel image belonging to the K-th frame of the m-th viewpoint image may be defined as I_{e,K,m,j}. The value of the m+6j+3-th pixel of the display panel in the K-th frame for the even numbered pixel image may be defined as P_{e,K,m+6j+3} and mapped as P_{e,K,m+6j+3}=I_{e,K,m,j}.

$$( 1 \leq m \leq 6.0 \leq j \leq \frac{N}{6} - 1 , m , j \text{:} integer )$$

FIG. 5D illustrates a process of outputting an odd numbered pixel image and an even numbered pixel image.

In an example, light paths (indicated by solid lines) of odd numbered pixel images and light paths (indicated by dotted lines) of even numbered pixel images may reach identical converging(*convergence points, for example, \textcircled{1} through \textcircled{6} of FIG. 5D, without the even numbered pixel images and the odd numbered pixel images overlapping or interfering with each other. The even numbered pixel images and the odd numbered pixel images may pass through the lenses 543 and 563 via pixels 590 included in the display panel. For example, the odd numbered pixel images, for example, the odd numbered pixel images 530 and 540, may pass through the pixels 590 and be transferred to eyes of the user via the lens 563 disposed at a first position. Subsequently, the even numbered pixel images, for example, the even numbered pixel images 550 and 560, to be input may pass through the pixels 590 and be transferred to the eyes of the user via the lens 543 moved from the first position to the second position. Moving distances of the lenses 543 and 563 may be adjusted based on a user setting or a method of mapping a viewpoint image to pixels included in the display panel.

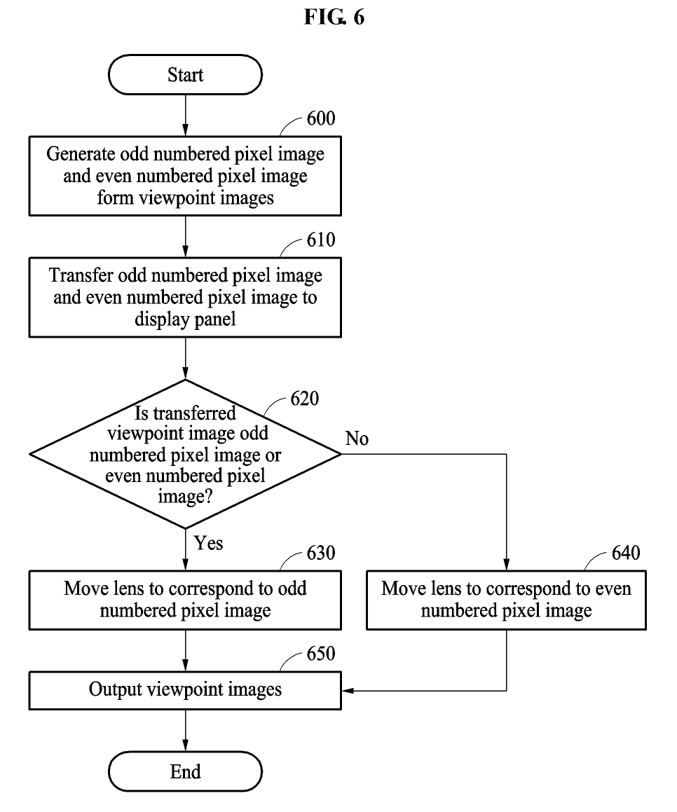

FIG. 6 is a flowchart illustrating a process of outputting a plurality of images in a display device according to an example embodiment.

In operation 600, a processor generates a plurality of viewpoint images and divides each of the viewpoint images into an odd numbered pixel image and an even numbered pixel image. In an example, the processor may increase twice a resolution of each of the viewpoint images and then divide each of the viewpoint images into the odd numbered pixel image and the even numbered pixel image. Each of the viewpoint images may be divided into the odd numbered pixel image and the even numbered pixel image, but the viewpoint images are not limited thereto. A viewpoint image may be divided into at least three division images. When a viewpoint image is divided into n division images, a frame rate of the viewpoint images may be increased three times.

In operation 610, the processor transfers the odd numbered pixel image and the even numbered pixel image to a display panel. Based on a user setting, the odd numbered pixel image and the even numbered pixel image may be transferred to the display panel based on different methods.

In operation 620, the processor verifies whether a viewpoint image transferred to the display panel is the odd numbered pixel image or the even numbered pixel image. In operation 630, when the odd numbered pixel image is transferred, the transferred odd numbered pixel image passes through the display panel and then a lens is moved to a first position such that the transferred odd numbered pixel image passes through the lens disposed at the first position.

In operation 640, when the even numbered pixel image is transferred, the transferred even numbered pixel image passes through the display panel and then the lens is moved to a second position such that the transferred even numbered pixel image passes through the lens disposed at the second position.

In operation 650, the viewpoint images that pass through the display panel and the lens may be sequentially transferred to eyes of a user. In general, an odd numbered pixel image of a K-th frame is transferred to the eyes of the user after an even numbered pixel image of the K-th frame is transferred to the eyes of the user. Subsequently, an even numbered pixel image of a K+1-th frame may be transferred to the eyes of the user after an odd numbered pixel image of the K+1-th frame is transferred to the eyes of the user. Thus, a viewpoint image of a relatively high resolution may be provided for the user when each of viewpoint images divided into an odd numbered pixel image and an even numbered pixel image are alternately transferred to the user at predetermined intervals.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) display device comprising:
a display panel configured to output a plurality of viewpoint images including a frame of an input image through a plurality of pixels of the display panel;
a lens configured to allow the plurality of viewpoint images output by the display panel to pass through the lens; and
a processor configured to control the display panel and the lens,
wherein the processor is configured to perform time-division on the plurality of viewpoint images such that the plurality of viewpoint images are divided into n division images, transfer the n division images to the display panel by increasing a frame rate of the n division images by n times, and control the lens such that the n division images transferred to the display panel pass through the lens.

2. The 3D display device of claim 1, wherein the processor is configured to control the lens such that a first division image among the n division images passes through a lens cell of the lens disposed at a first point, and control the lens such that a second division image among the n division images passes through a lens cell of the lens which is moved from the first position to a second position.

3. The 3D display device of claim 1, wherein the processor is configured to transfer a first division image among the n division images to the display panel based on a first mapping method, and transfer a second division image among the n division images to the display panel based on a second mapping method.

4. The 3D display device of claim 1, wherein the processor is configured to increase a resolution of the plurality of viewpoint images by n times and perform time-division on the plurality of viewpoint images of the n times increased resolution such that the plurality of viewpoint images of the n times increased resolution are divided into the n division images.

5. A method of controlling a three-dimensional (3D) display device including a display panel and a lens, the method comprising:
by one or more hardware processors:
performing time-division on a plurality of viewpoint images such that the plurality of viewpoint images are divided into n division images;
transferring the n division images to the display panel by increasing a frame rate of the n division images by n times; and
controlling the lens such that the n division images transferred to the display panel pass through the lens.

6. The method of claim 5, further comprising:
controlling the lens such that a first division image among the n division images passes through a lens cell of the lens disposed at a first point; and
controlling the lens such that a second division image among the n division images passes through a lens cell of the lens disposed at a second position which is moved from the first position.

7. The method of claim 5, further comprising:
transferring a first division image among the n division images to the display panel based on a first mapping method; and
transferring a second division image among the n division images to the display panel based on a second mapping method.

8. The method of claim 5, further comprising:
increasing a resolution of the plurality of viewpoint images by n times and performing time-division on the viewpoint images of the n-times increased resolution such that the viewpoint images of the N-times increased resolution are divided into n division images.
